(19) United States
(12) Patent Application Publication
(10) Pub. No.: US 2009/0209685 A1
(43) Pub. Date: Aug. 20, 2009

(54) Adhesive Solution for Application to the Skin

(76) Inventors: Alan Amass, Sutton Coldfield (GB); Maria Martinez-Velon, Pontevedra (ES)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/227,279

(22) PCT Filed: May 15, 2007
(86) PCT No.: PCT/GB2007/001798

§ 371 Date: Apr. 20, 2009

(30) Foreign Application Priority Data
May 17, 2006 (GB) 0609797.6

(51) Int. Cl. C08K 5/053; C08L 39/06; C08K 5/3445

(52) U.S. Cl. 524/105; 524/548; 524/387

(57) ABSTRACT

This invention relates to an adhesive solution for removably attaching items to the skin comprising: (i) a solids content comprising a vinyl pyrrolidone copolymer, and either a plasticiser, and a separate wetting agent, or a compound that acts as both plasticiser and wetting agent (ii) water as a first solvent; and (iii) an alcohol as a second solvent wherein the amount of alcohol does not exceed 20 wt % of the whole solution, and the glass transition temperature (Tg) of the copolymer composition (i) is below 40° C.

This invention relates to an adhesive solution for removably fixing items to the skin, especially items that are to be fixed to the skin around a wound or surgically-constructed opening such as a stoma. It is particularly applicable to fixing a colostomy, ileostomy or ureostomy bag having a hydrocolloid flange to the skin so that a stoma can drain into it. Such solutions are applied to the skin and become adhesive as they dry.

Adhesive solutions for the same purpose that are already in use comprise polymer components dissolved in an alcohol such as isopropanol. Other such products are in the form of emulsions rather than solutions.

Adhesive preparations containing a high proportion of alcohol are disliked by patients as they cause stinging when applied around an opening in the skin such as a stoma. Preparations in the form of emulsions are unsatisfactory in that they have limited storage life as the components of the emulsion tend to separate with the passage of time.

Apart from not causing stinging, it is important that an adhesive preparation for removably attaching items to the skin should dry and thus become effectively-adhesive reasonably quickly, preferably within about 60-70 seconds from the time of application.

According to this invention an adhesive solution for removably attaching items to the skin comprises:
(i) a solids content comprising a vinyl pyrrolidone copolymer, a plasticiser, and a wetting agent;
(ii) water as a first solvent; and
(iii) an alcohol as a second solvent
   wherein the amount of alcohol does not exceed 20 wt % of the whole solution, and the glass transition temperature (Tg) of the copolymer composition (i) is below 40° C.

Unless otherwise stated, all percentages are by weight.

Unlike previously-available adhesive solutions, comprising an alcohol such as isopropanol as the only solvent, the adhesive solutions of the invention, being largely water-based and containing only a minor amount of alcohol, do not sting when applied at a wound or surgically-constructed opening such as a stoma. It has also been surprisingly found that such solutions comprising water as the major solvent exhibit similar drying times to compositions comprising isopropanol as the only solvent, although isopropanol has a significantly-lower boiling point (82.4° C.) than water. Also, being solutions rather than emulsions, the adhesive solutions of the invention have a longer shelf life than emulsions as they do not tend to separate over time.

The alcohol is preferably isopropanol, although other alcohols such as ethanol and normal propanol may be used. The alcohol should not be of such a high molecular weight that its volatility is insufficient.

The copolymer is preferably a copolymer of PVP and vinyl acetate (PVP/VA). The proportion of vinyl pyrrolidone is preferably from 50-70 wt % and the proportion of vinyl acetate from 50-30 wt %. The most preferred copolymer comprises about 60 wt % of vinyl pyrrolidone and about 40 wt % of vinyl acetate This solution dries to a non-tacky film which is resistant to humidity. A copolymer comprising 70% vinyl pyrrolidone and 30% vinyl acetate is less preferred as it is more brittle (resulting from a higher glass transition temperature) and therefore requires a higher proportion of plasticiser. In addition, it is more soluble in water than a copolymer comprising 60% PVP and 30% VA, which tends to reduce its skin adhesion undesirably.

A variety of physiologically-acceptable plasticisers may be used, and the nature and amount of the plasticiser are selected so that the glass transition temperature of the copolymer composition is less than 40° C., and preferably less than 30° C., and most preferably from 20 to 30° C., e.g. about 22° C. One suitable plasticiser is ethoxylated pentaerythritol (PP150) (15/4EO/OH) which has a molecular weight of 797.

Examples of further possible plasticisers are polyethylene glycols, especially PEG 600 or PEG 200.

Laureth 7 (7, 3, 6, 9, 12, 15, 18, 21-heptoxatritriacontanol)-ethoxylated lauryl alcohol is one example of a compound that acts both as a plasticiser and as a wetting agent.

The adhesive solution may also contain up to about 0.5% by weight of bactericide as a preservative. One suitable preservative is “Germall plus” (trade mark—diazolidinyl urea and idopropynyl butylcarbamate).

The solids content (i) preferably contains at least 75% by weight PVP/VA copolymer and not more than 25% by weight of a combination of plasticiser and wetting agent. Of this combination, about 95% by weight is preferably plasticiser and 5% by weight wetting agent if the proportion of the plasticiser and wetting agent together exceeds 25%, the adhesiveness of the solution after drying will be undesirably decreased. The solids content (i) (i.e. polymer/plasticiser/wetting agent) preferably comprises from 27 to 33% (preferably 30%) of the whole adhesive solution. Of the remainder, about 70% is preferably water and about 10% isopropanol. Drying time increases and adhesiveness decreases if the solids content exceeds about 30%.

This adhesive solution may in addition comprise up to 0.5% of a bactericide as mentioned above and, if necessary, a pH modifier (e.g. sodium hydrogen carbonate) in order to adjust the pH to neutrality.

The adhesive composition is preferably prepared by first adding plasticiser, wetting agent, water and isopropanol in appropriate proportions to a 50% by weight aqueous solution of PVP/VA copolymer. The bactericide (e.g. “Germall plus” in the form of a solid powder) is then added and finally, and if required, a pH modifier, preferably sodium hydrogen carbonate, is added to adjust the pH to neutrality.

One adhesive solution according to the invention will now be described by way of Example only.

### EXAMPLE

A copolymer of vinyl pyrrolidone and vinyl acetate (commercially available under the trade name PVP/VA W635) in the form of a 50% by weight aqueous solution was taken and to it was added the plasticiser PP150 (ethoxylated pentaerythritol) (15/4 EO/OH-molecular weight 797), water, the wetting agent Laureth 7, such that the whole solution comprised 60% water, 10% isopropanol, and 30% solids comprising PVP/PA copolymer plasticiser and wetting agent. Of this the PVP/VA copolymer comprised 75%, and the plasticiser/wetting agent together 25%. Of the latter, the plasticiser comprised 95% and the wetting agent 5%.

To the resulting solution was added the preservative “Germall plus” (up to 0.5% of the whole composition). The pH was then checked by a pH meter and adjusted if necessary to pH 7 by the addition of sodium hydrogen carbonate.

When tested this solution was found not to cause stinging or other irritation when applied to the skin at a wound or around a surgical opening such as a stoma. At room temperature the drying time when applied to the forearm was 78 seconds and when applied to the stomach skin was 60 seconds. The adhesion was measured by impregnating a non-woven cloth (4×4 cm) folded double with 0.16 ml (0.194 g) of solution, and then wiping the impregnated cloth over 8 cm² of skin on the forearm. An average of 0.0237 g of the solution remained on the skin. This dried to a thin film. A pressure-sensitive hydrocolloid adhesive material was then applied to the coated area of skin, and left on the skin for 8 hours. After that time it was peeled off and the force/mm required to peel it off was measured, the result being 0.068 N/mm.

Thus the dried solution provided satisfactory adhesion to the skin whilst being easily peeled off when no longer required.

Although the adhesive solution has been described as being particularly suitable for fixing colostomy bags to the skin, it can also be used to fix other items to the skin such as needles or tubes for administering therapeutic solutions by infusion.

It may also be used as an adhesive for bandages or sticking plasters.

1. An adhesive solution for removably attaching items to the skin comprising:
(i) a solids content comprising a vinyl pyrrolidone copolymer, and either a plasticiser, and a separate wetting agent, or a compound that acts as both plasticiser and wetting agent
(ii) water as a first solvent; and
(iii) an alcohol as a second solvent
wherein the amount of alcohol does not exceed 20 wt % of the whole solution, and the glass transition temperature (Tg) of the copolymer composition (i) is below 40° C.

2. An adhesive solution according to claim 1, wherein the copolymer is a copolymer of vinyl pyrollidone and vinyl acetate.

3. An adhesive solution according to claim 2, wherein the copolymer comprises from 50-70 wt % of vinyl pyrollidone and 50-30 wt % of vinyl acetate.

4. An adhesive solution according to claim 3, wherein the copolymer comprises about 60 wt % of vinyl pyrollidone and about 40 wt % of vinyl acetate.

5. An adhesive solution according to claim 1, wherein the plasticiser is ethoxylated pentaerythritol or a polyethylene glycol.

6. An adhesive solution according to claim 1, wherein the compound that acts both as plasticiser and wetting agent is 7, 3, 6, 9, 12, 15, 18, 21-heptoxatritriacontanol.

7. An adhesive solution according to claim 1, wherein the solids content is about from 27 to 33% by weight of the whole solution.

8. An adhesive solution according to claim 7, comprising about 60% water and 10% isopropanol.

9. An adhesive solution according to claim 1, wherein the glass transition temperature (Tg) is less than 30° C.

10. An adhesive solution according to claim 9, wherein the glass transition temperature (Tg) is from 20-30° C.

11. An adhesive solution according to claim 1, comprising up to 0.5 wt % of a physiologically-acceptable preservative.

12. An adhesive solution according to claim 11, wherein the preservative is a mixture of diazolidinyl urea and idopropynyl butylcarbamate.

13. An adhesive solution according to claim 1, having a pH of about 7.

14. An adhesive solution according to claim 13, wherein the pH is adjusted to about 7 by addition of sodium hydrogen carbonate.

15. An adhesive solution according to claim 1, wherein the alcohol is isopropanol.
